(19) United States
(12) Patent Application Publication
(10) Pub. No.: US 2011/0159976 A2
(43) Pub. Date: Jun. 30, 2011

(54) A Golf Diagnosis Apparatus And A Method Of Performing Golf Diagnosis

(75) Inventors: Kristian Hohla, Munich (DE); Roland Toennies, Olching (DE); Martin Hohla, Munich (DE)

(73) Assignee: Rangetainment Technologies GmbH, Munich (DE)

(21) Appl. No.: 12/747,314

(22) PCT Filed: Oct. 22, 2008
(86) PCT No.: PCT/EP2008/008940

§ 371 Date: Aug. 11, 2010

Related U.S. Application Data
(60) Provisional application No. 61/013,201, filed on Dec. 12, 2007.

(51) Int. Cl. A63B 69/36; G06F 19/00

(52) U.S. Cl. 473/199; 700/91; 473/409

(57) ABSTRACT

A golf diagnosis apparatus, comprising a first acquisition device adapted for acquiring first information indicative of a performance, particularly a stroke, of a golf player, the first acquisition device being directed along a first direction, a second acquisition device adapted for acquiring second information indicative of the performance, particularly the stroke, of the golf player, the second acquisition device being directed along a second direction which differs from the first direction, and a data evaluation unit adapted for evaluating the first information and the second information to determine golf diagnosis related data, wherein the first direction is parallel to and the second direction is perpendicular to a motion vector of a golf ball hit by the golf player.

### CROSS REFERENCE TO RELATED APPLICATION

This application claims the benefit of the filing date of U.S. Provisional Patent Application No. 61/013,201 filed Dec. 12, 2007, the disclosure of which is hereby incorporated herein by reference.

### BACKGROUND

The invention relates to a golf diagnosis apparatus.

The invention further relates to a method of performing golf diagnosis.

Moreover, the invention relates to a method of using a golf diagnosis apparatus on a driving range.

A golf diagnostic device is an electronic device for the determination of flight parameters of the flight path of a golf ball and may help a user to analyze and improve her or his golf performance.

WO 00/41776 discloses a system for recording and analyzing an activity, such as a golf activity. The system comprises a video capture unit for recording and displaying recorded activities. Preferred activities are saved, and may be viewed at a separate viewing unit located remote from the video capture unit. The remote viewing unit allows for replay and analysis of the saved activities. In addition, saved activities and data may be uploaded to the Internet for later viewing and analysis. Through any PC or other connection to the Internet, the user may input personal identification information associated with the saved images, and download the images for viewing. Analysis tools may be downloaded for use with the saved images. A Doppler radar unit may be incorporated for sensing and recording shot parameters such as distance, club head speed, ball speed, launch angle, and a shot efficiency percent. These “numerical analysis” statistics can be displayed on a monitor screen alongside an instant replay of the swing to enable the user to accurately gauge and measure performance.

US 2007/0075891 A1 discloses a ball measuring apparatus capable of measuring a trajectory of a ball from a hitting position to a landing position, the landing position and a stop position. Such a ball measuring apparatus includes a first millimeter wave radar device capable of carrying out a measurement from the hitting position to a predetermined position of the trajectory and having at least one transmitting antenna and a plurality of receiving antennas, and a second millimeter wave radar device capable of measuring the stop position and having at least one transmitting antenna and a plurality of receiving antennas. Another ball measuring apparatus has a millimeter wave radar device and a CCD camera.

WO 2001/21266 A1 discloses a small vehicle designed to support golf players and professionals and allowing computer assisted teaching and training either in indoor or outdoor driving ranges. It uses a multimedia system that includes a computer, digital video camera and speed radar all in association with some peripherals for interface communication, namely, two video screens, a printer, a biometrics identification system, a touch pad and the vehicle that carries all the system. Operation starts positioning the vehicle in front of the player and recording the images of the swing. It is possible to observe in both screens live images or to repeat all at normal speed, slow motion or frame by frame, forward or backward. Video images are digitized and saved in the hard disk of the computer as computer files. An estimate of the distance reached by the golf ball is displayed.

US 2005/0026710 discloses a video image acquisition apparatus. The apparatus has one or multiple digital cameras taking images of a flying golf ball created by at least two flashes or strobes of light on continuous video mode at a predetermined frame rate. Each image frame is then subtracted from the background and compared to determine the existence of the ball image in flight thus eliminating a dependency upon the camera shutter speed which must be synchronized with the flashes in conventional design. Furthermore, another video image acquisition apparatus is also disclosed that consists of at least two video cameras taking images of flying golf balls created by at least two flashes or strobes of light at predetermined time intervals. The apparatus then applies triangulate calculation of the two camera images to determine the exact physical locations of the flying golf balls in space at a given time of flight.

GB 2,371,236 A discloses a system for capturing and analyzing golf club information and golf ball information during and after a golfer's swing. The golf club information includes golf club head orientation, golf club head velocity, and golf club spin. The golf ball information includes golf ball velocity, golf ball launch angle, golf ball side angle, golf ball speed manipulation and golf ball orientation. The system comprises camera units, a trigger device and a computer. The trigger device once activated by the passing of the golf club sets the camera shutter speed for the first camera and second camera with the shutter speeds of each camera being different. The first and second cameras then take a plurality of exposures before and after the golf ball has been struck. The plurality of exposures are then displayed as a single frame on a PC monitor as a set of readings.

However, conventional golf diagnosis systems suffer from the fact that they may lack accuracy, and they may further suffer from spatial problems.

### SUMMARY

It is an object of the invention to provide a sufficiently accurate golf diagnosis system.

In order to achieve the object defined above, a golf diagnosis apparatus, a method of performing golf diagnosis, and a method of using a golf diagnosis apparatus on a driving range according to the independent claims are provided.

According to an exemplary embodiment of the invention, a golf diagnosis apparatus is provided comprising a first acquisition device adapted for acquiring first information (for instance first data) indicative of a performance, particularly a stroke, of a golf player, the first acquisition device being directed (or aligned, i.e. a viewing or sensing direction of the first acquisition device may have a dedicated orientation) along a first direction, a second acquisition device (differing from the first acquisition device) adapted for acquiring second information (for instance second data) indicative of the performance, particularly the stroke, of the golf player, the second acquisition device being directed (or aligned, i.e. a viewing or sensing direction of the second acquisition device may have a dedicated orientation) along a second direction which differs from the first direction (particularly there may be an angle different from zero degrees, particularly larger than 10°, more particularly larger than 45°, further particularly about 90°, between the first direction and the second direction), and a data evaluation unit (such as a processor) adapted for evaluating the first information and the second information (particularly in combination) to determine golf diagnosis related data.

According to another exemplary embodiment of the invention, a method of performing golf diagnosis is provided, the method comprising acquiring first information indicative of a performance, particularly a stroke, of a golf player by a first acquisition device being directed along a first direction, acquiring second information indicative of the performance, particularly the stroke, of the golf player by a second acquisition device being directed along a second direction which differs from the first direction, and evaluating the first information and the second information to determine golf diagnosis related data.

According to still another exemplary embodiment of the invention, a method of using a golf diagnosis apparatus, particularly an autarkic golf diagnosis apparatus, having the above-mentioned features on a driving range is provided.

Processing capabilities of the golf diagnosis scheme according to embodiments of the invention can be realized using computer programs, that is by software, or by using one or more special electronic optimization circuits, that is in hardware, or in hybrid form, that is by software components and hardware components.

The term “the first direction is parallel to and the second direction is perpendicular to a motion vector of a golf ball hit by the golf player” may particularly denote that the two directions are exactly perpendicular to one another. However, this term also covers embodiments in which the fields of view of the two acquisition devices are directed generally into the two different directions in which the flying ball is inspected from a side position and in which the flying ball is inspected from a rear position. The center of the two fields of views should include an angle in a range between 70° and 110°, particularly in a range between 80° and 100°, more particularly in a range between 85° and 95°, preferably around 90°. The skilled person will understand that the non-zero fields of view may result in a deviation from an exact 90° angle. The feature of a parallel and a perpendicular direction should be understood in a broad sense and should indicate that one of the acquisition devices takes a close-up side view directly after launching (and/or for determining the ball position) and the other one of the acquisition devices provides an overview later after launching from a rear position.

The term “evaluating the first information and the second information to determine golf diagnosis related data” may particularly denote that the data evaluation unit may be adapted for evaluating first information from the first acquisition device and second information from the second acquisition device to determine golf diagnosis related data. In such a configuration, both the first information as well as the second information may be evaluated together in order to estimate at least one parameter value which is characteristic for the quality of the stroke or is the result of a golf diagnosis. Calculation of this parameter value involves both the first information and the complementary second information and is therefore less prone to introduce artifacts which may influence one specific measurement technique under specific environmental conditions. Hence, the data sets provided by both the acquisition devices do not stand side by side in an isolated manner, but may be combined to form two items of input data used as a basis for determining output data reflecting the sensitivity of both measurement methods. In an embodiment, the first information and the complementary second information may be subject of a combined analysis to thereby obtain meaningful golf diagnosis results.

The term “performance” of a golf player may particularly denote any action a golf player takes before, during or after carrying out a stroke. This may particularly include the behavior before the stroke, for instance when the golf player walks to the tee. It may particularly include the behavior directly before the stroke, for instance when the golf player stands in front of the tee and concentrates before carrying out the stroke. It may particularly include the behavior during the stroke, for instance when the golf player swings the golf club and hits the golf ball. It may particularly include the behavior after the stroke, for instance when the golf ball has left the tee/golf club and flies in the direction of the goal.

In the context of this application, the term “stroke” may particularly denote the entire procedure or a part of the procedure including a swing with the golf club, a hit between golf club and golf ball, and the flight of the golf ball until the ball rests. A stroke may be at least a part of the performance. A stroke may include the club orientation at impact, and optionally a swing path.

The term “golf diagnosis apparatus” may particularly denote an apparatus which may monitor the performance of a golf player and may carry out calculations in correspondence with this performance. Also golf simulators may be covered by the term “golf diagnosis apparatus”. For instance, such a golf diagnosis apparatus may comprise one or more cameras making one or more pictures (in a single picture mode or in a continuous video mode) of a golf ball and/or a golf club and/or a golf player in order to derive therefrom information allowing to perform a diagnosis of a golf stroke. Such a golf diagnosis apparatus may comprise at least one further acquisition device acquiring additional data characterizing a golf ball and/or a golf club and/or a golf player in order to derive therefrom complementary information allowing to perform a diagnosis of a golf stroke with improved precision.

For instance, a flash or a stroboscope may define different points of time at which an image is taken, and the individual images may be evaluated using image recognition methods so as to analyze a stroke of a golf player. For instance, a radar may capture data which may be evaluated so as to analyze a stroke of a golf player. According to an exemplary embodiment, such a radar may be located in front of the golf player, when viewing in stroke/ball flight direction, rather than behind the player. When being arranged several meters behind a player on a driving range, it may happen that the radar device would capture an image of persons walking between the radar device and the golfer, which might disturb the measurement. Closing the connecting passage between radar and golfer may be undesired or impossible on a driving range. However, when being located behind the golfer, the radar would be able to measure both a trajectory of the hit golf ball as well as information regarding the swinging golf club and consequently club orientation at impact. According to an exemplary embodiment, a radar may be located in front of the golf player to exclusively detect information indicative of the ball trajectory. This information may then be combined with data captured by another acquisition unit to derive lacking information regarding club orientation at impact. For instance, such a golf diagnosis apparatus may calculate parameters like velocity, angle, acceleration, spin, stroke distance, etc. in accordance with a stroke. Such a system may be implemented also in combination with a self-adaptive golf analysis feature, allowing to determine which body positions, or other stroke parameters statistically yield good results, and which not. Thus, such a golf diagnosis system may provide a golfer with suggestions as to how to improve the performance or provide information which parameters have been successful in the past.

In the context of such a golf diagnosis apparatus, a golfer may position a golf ball on the tee, may select a golf club and may carry out a stroke. In the vicinity of the tee, the user may position the golf diagnosis apparatus which may comprise, integrated therein, multiple acquisition devices so that redundant data can be captured before, during and/or after hitting the ball. Such at least partially redundant data may then be evaluated, with respect to ball, golf club, and/or body position of the golfer so as to derive parameters allowing to perform a diagnosis of a stroke so as to evaluate the quality of the stroke.

According to an exemplary embodiment of the invention, a golf diagnosis apparatus is provided which comprises two complementary acquisition units. A first acquisition unit may be directed or oriented to be capable of viewing or to have a viewing direction essentially in parallel to a flying ball (from a back position seeing the departing golf ball, or from a front position seeing the approaching golf ball). Simultaneously, a second acquisition unit may be arranged or located to capture one or more images of the hit ball directly after the hit and may be directed or oriented to be capable of viewing or to have a viewing direction essentially perpendicular to the flying ball, for instance using a strobe and camera system. Both evaluation systems may allow to determine individual information indicative of the golf stroke. Such information may include spin, angle, velocity, stroke width, etc. By taking the measures of embodiments of the invention, a golf practicing experience may become more efficient and more entertaining.

However, under undesired circumstances, such as wind or a stroke with a very low quality, it may happen that one individual acquisition entity is not capable of determining the golf diagnosis related data with sufficient accuracy. However, by providing two complementary acquisition entities which are sensitive to information regarding different directions, it may become possible to significantly improve the accuracy and reliability of the results, since both measurements can be evaluated simultaneously. Such a simultaneous evaluation may comprise averaging procedures, comparison of the data regarding plausibility, or the elimination of one set of data when it is determined that there are significant doubts regarding the reliability of this set of data. By taking this measure and by combining data items which are complementary to one another, the percentage of reliable determination events may be increased up to almost 100%.

The implementation of a strobe-camera arrangement for one of the acquisition units may allow to measure the ball flight parameter without an influence of the surrounding conditions (such as wind, dimple structure of a golf ball, etc.). This is an important circumstance regarding the calculation of the club orientation at the moment of the hit. It may allow to calculate the ball flight without surrounding conditions (that is under estimated standard conditions, for instance without an influence of wind), and may allow to obtain absolutely comparable conditions. However, the spin determination may be dependent on image processing properties when using strobes. The latter limitation can be overcome by using a radar device as the other acquisition entity, which however may have some limitations regarding the geometrical construction which can be overcome by taking into account the strobe camera-based measurement data. The present inventors have recognized that surprisingly the combination of a strobe camera-based measurement with a radar measurement having different sensing directions may be particularly appropriate for error robust golf diagnosis.

According to an exemplary embodiment of the invention, a golf ball trajectory and impact diagnostic system is provided comprising a stroboscopic, diode or radar based measuring device placed perpendicular to the target line to measure at least ball speed, horizontal and vertical launch angle and at least one spatial position of the moving ball and b) an optical, radar or ultrasound measuring device placed parallel to the target line to measure at least one spatial position of the flying ball (for instance at least 1 m after the position of the stroboscopic measurement) c) wherein a) and b) may be placed in a fixed spatial relation to each other d) and a data evaluation unit and algorithm combining both independent measurements to determine relevant launch parameters including the spin of the ball derived from both independent measurements to accurately predict the true trajectory (independent of/minimizing the impact of wind and other atmospheric disturbing influences on the trajectory) of the ball and to calculate from these data the impact parameter of the club relevant to the target line.

Thus, it may become possible to measure the ball flight and to calculate the impact with sufficient precision.

Next, further exemplary embodiments of the golf diagnosis apparatus will be explained. However, these embodiments also apply for the method of performing golf diagnosis and for the method of using the golf diagnosis apparatus on a driving range.

The first direction may be perpendicular to the second direction. The first direction may be essentially perpendicular to the second direction. In other words, there may be an angle of about or exactly 90° between the viewing or sensing direction of the first acquisition device and the viewing or sensing direction of the second acquisition device. Therefore, different projections of the three-dimensionally movable golf ball may be captured, allowing to derive independent and complementary data with both measurements.

The first direction may be (for instance exclusively) essentially parallel to and the second direction may be (for instance exclusively) essentially perpendicular to a motion vector of a golf ball hit by the golf player. In other words, the angle between the first direction and the motion vector of the golf ball may be either essentially 0° or essentially 180°. In other words, the first acquisition device may follow the departing golf ball or may follow the approaching golf ball, depending on the orientation of the first acquisition device. In contrast to this, the second direction may be normal to the motion vector or essentially normal to the motion vector which makes it for instance possible to capture images of a golf ball directly after the stroke by taking one, two or more snap shots which show the golf ball in an image moving from a left low position to a right high position on an image, or vice versa. Since in reality, there may be a deviation from a completely straight stroke (for instance there may be a horizontal golf ball launch angle of several degrees, for instance differing from zero degrees), the skilled person will recognize that the parallel and perpendicular directions relate to an ideal straight stroke.

When the golf diagnosis apparatus is mounted on a ground, the first acquisition device may be mounted at a higher vertical position than the second acquisition device which may be mounted at a low position close to the ground. Thus, the second acquisition device may be mounted to be specifically sensitive on the motion of the golf ball directly after the stroke, i.e. close to the tee, whereas the first acquisition device may be mounted at an elevated portion to enable the first acquisition device to follow the flying golf ball over a long portion of the entire flight with sufficient accuracy.

The first acquisition device and the second acquisition device may be different types of acquisition devices. In other words, the physical measurement principle of the acquisition devices may be different. For instance, the probe (for example light, radio frequency, acoustic waves) used by the two acquisition devices may be different. This may promote the independent usability of the data captured by the two acquisition devices. For instance, a light-based measurement may suffer in the presence of poor illumination conditions or large distances where a radar based RF measurement is still accurate. On the other hands, while an acoustic wave based measurement may have a weak performance in the presence of ambient noise, ambient noise does not disturb an electromagnetic radiation based measurement. Therefore, even under harsh conditions, artifacts having an impact on a specific measurement principle will not influence another measurement principle making the entire system less prone to failure.

The first acquisition device and the second acquisition device may be adapted for acquiring complementary information indicative of the performance, particularly the stroke, of the golf player. In this context, the term “complementary” may denote that the construction, the positioning, the orientation, the arrangement and the image acquisition type of the acquisition devices may be selected so that artifacts to which the first acquisition device is prone do not occur in the context of the second acquisition device, and vice versa. Thus, the first acquisition device and the second acquisition device may be adapted to not only provide redundant data, but to provide data which, in combination, reduce the risks of determining a false result. Thus, several items of complementary information may complete the whole, or may mutually make up what is lacking from one item of information alone. Thus, the first information and the second information may complete each other to eliminate a lack of information which conventionally yields the risk of determining incorrect results such as an incorrect stroke width.

The first acquisition device and/or the second acquisition device may be a camera for capturing one or more snap shots of a golf ball hit by the golf player. Such a camera may be operated in connection with a strobe or a flash so that one, two, three, four or more instantaneous projections of the golf ball during the motion over the first several decimeters can be captured. Evaluating information such as size of the golf ball on the various images, distance of the golf ball between adjacent images, different rotational positions of markers on the golf ball, etc., may allow to determine golf diagnosis related data such as speed, acceleration, spin, angular information, stroke width, etc.

The first acquisition device and/or the second acquisition device may comprise a camera for capturing a video of a golf ball hit by the golf player. Providing such a video camera and capturing a video film of the flying golf ball may allow to determine meaningful information regarding the golf ball and, in contrast to the snap shot embodiment, has the advantage that the rich source of information can help to eliminate ambiguities, for instance when a marker is not shown on an individual image of the golf ball since it is presently positioned on a backside. Moreover, strobes may be dispensable when using a video camera.

More particularly, the first acquisition device and/or the second acquisition device may comprise a high-speed camera capturing many images per time interval. For instance, such a high-speed camera may capture a thousand images per second, or more.

The first acquisition device and/or the second acquisition device may comprise an ultrasound detector for capturing ultrasound of a golf ball hit by the golf ball player. It is also possible that such an ultrasound detector has an ultrasound emission function, so that ultrasound reflected by the golf ball can be detected to provide the information regarding the stroke.

The first acquisition device and/or the second acquisition device may comprise a radar unit for emitting primary electromagnetic radiation to a golf ball hit by the golf ball player and for receiving secondary electromagnetic radiation from the golf ball in response to the reflection of the primary electromagnetic radiation by the golf ball. Such a radar system may use electromagnetic waves to identify the range, altitude, direction, speed, etc. of a moving object such as a golf ball. A transmitter of the golf diagnosis apparatus emits radio waves which are reflected by the target golf ball and detected by a receiver of the golf diagnosis apparatus which may be located close to the transmitter. A radar is specifically suitable to detect the golf ball at ranges where other detection signals, such as sound, ultrasound or visible light, might become too weak to be detected and to achieve a sufficient resolution.

According to an embodiment, the first acquisition device may comprise a radar unit for emitting primary electromagnetic radiation to a golf ball hit by the golf player and for receiving secondary electromagnetic radiation from the golf ball in response to the reflection of the primary electromagnetic radiation at the golf ball. The second acquisition device may comprise a ball finder system for detecting a launch position and a launch time of a golf ball hit by the golf player. The ball finder may comprise a camera for detecting a ball position before launching and a trigger (such as an optical trigger or a logically combined optical and acoustical trigger) for detecting a point of time when the ball is hit. The radar data may be evaluated with the help of the output of the ball finder. Such an embodiment is shown in FIG. 11.

The first acquisition device and/or the second acquisition device may comprise a lidar unit for emitting primary electromagnetic radiation to a golf ball hit by the golf player and for receiving secondary electromagnetic radiation from the golf ball in response to the reflection of the primary electromagnetic radiation at the golf ball. Lidar (Light Detection and Ranging) may be denoted as an optical remote sensing technology that measures properties of scattered light to find range and/or other information of a distant target such as a hit golf ball. Like the similar radar technology, which uses radio waves instead of light, the range to an object is determined by lidar by measuring the time delay between transmission of a pulse and detection of the reflected signal.

A combination of a radar device as the first acquisition unit and a strobe-based snap shot camera as the second acquisition device has turned out to be particularly advantageous. It has turned out surprisingly that this combination yields very reliable results.

It should be noted that the two measurements performed by the first acquisition device and the second acquisition device may be introduced into an algorithm to derive, by computation in combination, golf diagnosis related information. Thus, the two pieces of information are not treated completely separately, but may be actively analyzed by the golf diagnosis apparatus to suppress artifacts. Thus, the two measurement results are not only displayed in a juxtaposed manner to a golf player, but may be actively interpreted by the golf diagnosis apparatus to increase the reliability of resulting information.

The data evaluation unit may be adapted for evaluating the first information and the second information to determine combined golf diagnosis related data. The data evaluation unit may be adapted for (for example sequentially or simultaneously) evaluating the first information and the second information to determine the golf diagnosis related data. Such a simultaneous evaluation may include a statistical analysis, an averaging procedure, a plausibility check of each of the results, or the elimination of a suspicious data component. Thus, the first information and the second information are not only treated individually, but are combined synergistically to benefit from the different sensitivity characteristics of both acquisition units.

The data evaluation unit may be adapted to determine golf diagnosis related data of the group consisting of a golf ball speed, a golf ball spin, a horizontal golf ball launch angle, a vertical golf ball launch angle, a spatial position of a golf ball, a flight path of a golf ball (i.e. a trajectory), and a stroke width of a golf ball. These and other golf diagnosis related parameters may be output to a user and may also be combined to evaluate an efficiency of the stroke which can be output to the user.

The golf diagnosis apparatus may comprise a casing in and/or on which the first acquisition device, the second acquisition device and the data evaluation unit are accommodated. Both acquisition systems as well as the evaluation unit may therefore be included in an autarkic system which may have the appearance of a box or a tower having all elements integrated therein, allowing for a compact design and forming also the basis to install the golf diagnosis apparatus in an environment, in which only a small space is provided, for instance an array of bays of a driving range.

Particularly an oblong tower with an extension in the vertical direction which is significantly larger, for instance 2 to 10 times larger, than dimensions in the horizontal directions has turned out to be particularly useful since this allows to install the first image acquisition device at an elevated position, and the second acquisition device at a low position close to the ground while simultaneously maintaining a compact design. Also a planar tower with an extension in the vertical direction and in one horizontal direction which are significantly larger, for instance 2 to 10 times larger, than another dimension in the horizontal direction has turned out to be particularly useful since this allows to maintain a compact design while providing a sufficiently large area of a cover plate facing the golf player so that instruments such as a display or input elements may be arranged on this cover plate. Such a planar geometry may at the same time by space saving since due to its flat configuration, it can be arranged parallel to a one dimensional array of golf diagnosis sections on a driving range.

The casing may have a recess or a hole (for instance in a central portion) so that a camera can look through the casing from a back position.

The casing may have a cuboid shape having six cover surfaces, wherein the first acquisition device and the second acquisition device may be arranged at two cover surfaces which are adjacent and perpendicular to one another. Such a geometry of a cuboid perfectly fits to the architecture of the golf diagnosis apparatus having the two acquisition devices with different orientations. Namely, two perpendicular cover surfaces next to one another may be used for installing the two image acquisition devices. The second acquisition device which may be adapted for capturing images of the golf ball directly after the stroke may also be an appropriate cover surface for installing user interface components such as a display, buttons, a payment slot, etc. The first acquisition device may be arranged at a first cover surface and the second acquisition device may be arranged at a second cover surface, wherein the first cover surface and the second cover surface are adjacent to one another and are perpendicular to one another.

The golf diagnosis apparatus may comprise a power supply unit for supplying at least a part of the golf diagnosis apparatus with electrical energy and being accommodated in the common casing. The golf diagnosis apparatus may be an autarkic golf diagnosis apparatus comprising a power supply unit for supplying at least a part of the golf diagnosis apparatus with electrical energy and being accommodated in the common casing. Such a power supply unit may be a (for example rechargeable) battery, or may also include a solar cell. The power supply unit may be rechargeable with an electrical connection, so that the power supply unit may be recharged using a mains supply. It is also possible that a power supply unit is provided externally of, that is to say outside, the autarkic device.

The golf diagnosis apparatus may comprise an optical display unit for displaying the golf diagnosis related data and being accommodated in/on the common casing. The optical display unit may particular be accommodated at the second cover surface. The optical display unit may be a monitor, like an LCD monitor, a TFT monitor, an OLED (organic LED) based display, a plasma monitor or a cathode ray tube.

The golf diagnosis apparatus may comprise a user interface unit for allowing a user to communicate with at least a part of the golf diagnosis apparatus and being accommodated in the common casing, particularly being accommodated at the second cover surface.

An image acquisition device may be a camera, for instance a CCD camera. It is also possible to provide a plurality of cameras, for instance for capturing images of a golf stroke from different positions or different angles.

The golf diagnosis apparatus may comprise a microphone unit for acoustically detecting a stroke of a golf player and being accommodated in/on the common casing. The microphone unit may be accommodated at the second cover surface. When a golf club has hit the golf ball, this can be detected acoustically by the microphone. This detection may be used by a central control unit for triggering the detection of one or more images by an image acquisition device and for triggering the detection by a radar acquisition device. This may ensure that the captured image or images is or are really meaningful, since they are not taken before the ball is hit.

The golf diagnosis apparatus may comprise an optical detection unit for optically detecting a stroke of a golf player and being accommodated in/on the common casing. The optical detection unit may particular be accommodated at the second cover surface. Such an optical trigger may include a light barrier. It is possible to use a flashlight (for instance generated using a plasma discharge device), and/or may implement one or more LEDs.

According to an exemplary embodiment, a microphone unit and an optical detection unit may be used for detecting a stroke of a golf player with improved accuracy. The combination of these two complementary hit moment detection methods may allow for a precise estimation of the club-ball impact even in the presence of disturbing influences.

The golf diagnosis apparatus may comprise an ultrasound emission unit for emitting ultrasonic waves towards a golf ball and comprising an ultrasound detection unit for detecting ultrasonic waves reflected from the golf ball for detecting a stroke of a golf player, wherein the ultrasound emission unit and the ultrasound detection unit are accommodated in/on the common casing. The ultrasound emission unit and the ultrasound detection unit may be accommodated at the second cover surface. Thus, by irradiating the ball with ultrasound and by measuring the response, the stroke may be detected, since the reflection properties may be altered when the ball is hit and moves away from the tee. Therefore, an ultrasound trigger may be provided.

The golf diagnosis apparatus may comprise a flash unit for generating pulses of electromagnetic radiation. The flash unit may be provided for generating pulses of electromagnetic radiation and may be accommodated in the common casing, particularly may be accommodated at the second cover surface. One or more flashlight units, for instance strobes, may be provided so as to define different points of time at which a golf ball shall be visible at an image of the camera. By taking a plurality of images of the golf ball and/or of the golf club and/or of the golf player, it is possible to derive motion parameters from the captured images.

The golf diagnosis apparatus may further comprise a memory unit accessible by the data evaluation unit and being adapted for storing at least one of the group consisting of a golf diagnosis routine, an operating system (like Windows™ or Linux™), a history database indicative of previously determined golf diagnosis related data, or other information.

The data evaluation unit may be a CPU (central processing unit) or a microcontroller and may be functionally coupled with a storage device. Such a data evaluation unit may carry out calculations in accordance with prestored algorithms so as to derive golf analysis related parameters from the captured information using data from both the first and the second acquisition device. The memory may be an electronic storage medium like a volatile or non-volatile memory, a flash memory cell, an EPROM, an EEPROM, etc. The software stored in such a memory may be the actual golf evaluation software. Furthermore, a database including data indicative of previous strokes or of strokes performed by golf professionals may be stored in the storage device. Accessing these information, the control unit may provide the corresponding capabilities.

The casing may be at least one of weatherproof and shock-resistant. The casing of the golf diagnosis apparatus may be configured so that the entire golf diagnosis apparatus may be weatherproof and or shock-resistant. For this purpose, sealings may be provided so that the casing is water-resistant. The material of the casing (for instance any plastic or metallic material) may be selected so that the golf diagnosis apparatus may be used even under harsh conditions, for instance in the presence of dirt. To make the autarkic device shock-resistant, shock-absorbing (for instance mechanically damping) elements may be provided which may be integrated in the casing and/or may be attached externally to the casing.

The golf diagnosis apparatus may be shaped like a cuboid, particularly like a cube. The golf diagnosis apparatus may be essentially shaped like a cuboid, particularly essentially like a cube, a plate or a tower. Therefore, an easy to handle box may be provided, for instance with dimensions in the order of magnitude of 20 cm×20 cm×20 cm. For implementation on a driving range, a flat and high geometry may be appropriate, for instance having a width of 40 cm to 80 cm (particularly 60 cm), having a height of 150 cm to 180 cm (particularly 170 cm), and having a depth of 5 cm to 20 cm (particularly 10 cm).

The golf diagnosis apparatus may comprise a payment unit adapted for receiving a means of payment (such as at least one coin, at least one bank note, a credit card, a ticket, a cash card, etc.) from a user and may be adapted for enabling the user to operate (or use) the autarkic golf diagnosis apparatus only upon receipt of the means of payment. In other words, the golf diagnosis apparatus may be provided with a reception for receiving money, chip cards, etc., via which a user wishing to have his/her stroke captured and evaluated by the diagnosis device can activate the machine. Only after insertion of the means of payment in the reception unit (such as a slot or a card reader), the golf diagnosis apparatus will be operable/usable by the golf player. Optionally, the golf diagnosis apparatus may check the validity of the payment before allowing the user to use the device.

The payment unit may be adapted for enabling the user to operate the golf diagnosis apparatus upon receipt of the means of payment for a predetermined time or a predetermined number of strokes. Thus, depending on the amount of the payment made or initiated, the user will be enabled to use the diagnosis device for a certain time (for instance 10 minutes or 20 minutes), for a number of strokes (for instance 10 strokes or 50 strokes), or for a number of holes (for instance 3 holes).

The golf diagnosis apparatus may be installed (at a fixed position or at a variable position) on a driving range or at any other position of a golf course (for instance adjacent each tee). For instance, a separate golf diagnosis apparatus may be installed at each hole of a golf course, or at a part of the holes. Alternatively, the golf diagnosis apparatus may be installed at a driving range. The golf diagnosis apparatus may be provided with a golf game function (for instance distance targets). When a golfer wishes a golf diagnosis for a particular stroke, he/she can insert money in the slot of the diagnosis device and will therefore make the device ready for capturing and evaluating the next stroke(s) of the golfer.

The golf diagnosis apparatus may comprise an anchoring mechanism adapted for fixing the autarkic golf diagnosis apparatus at a horizontal support member (such as a base plate or a ground) or at a vertical support member (such as a wall).

When a golf diagnosis apparatus is fixedly installed at a golf course, the golf diagnosis apparatus may be fixed to the ground by an anchor mechanism anchoring the golf diagnosis apparatus at the ground (for instance by screwing the golf diagnosis apparatus at the ground or by embedding the golf diagnosis apparatus partially in the ground) or by installing the golf diagnosis apparatus on a base. The golf diagnosis apparatus may thus be protected against theft and removal. It may be provided with a fixed housing which protects the apparatus against humidity and mud, thereby allowing to use the golf diagnosis apparatus outdoor and even under harsh conditions. The golf diagnosis apparatus may thus be configured to be waterproof. Alternatively, the device may be portable and may be connected via bolts to a ground and may be locked there.

When a golf diagnosis apparatus is fixedly installed at a vertical wall, the golf diagnosis apparatus may be fixed to the wall by an anchor mechanism anchoring the golf diagnosis apparatus at the wall (for instance by screwing the golf diagnosis apparatus at the wall). Such a wall may be an interior or exterior wall of a building or may be a wall of a golf play box.

A field of view of the first acquisition device may be arranged in a non-overlapping manner (that is without spatial overlap) with a field of view of the second acquisition device. Each of the acquisition devices may have a characteristic viewing angle or spatial range of sensitivity over which objects within the corresponding spatial range can be detected. In an embodiment, there is no overlap between the fields of view of the two acquisition devices. Consequently, both acquisition devices can be specifically designed to optimally fulfill a specific task without involving any redundancy of data acquisition. For instance, the field of view of the first acquisition device may be configured to capture data from a position behind the flying golf ball. This data can be synergistically combined with data captured immediately after hitting the ball from a close-up view of the ball leaving the club.

The first acquisition device may be adapted for acquiring the first information within a first time interval or a first time window, and the second acquisition device may be adapted for acquiring the second information within a second time interval or a second time window preceding the first time interval. In other words, the image of the golf ball directly after the hit is acquired before acquiring information regarding the flight of the ball.

The present inventors have recognized that it is particularly advantageous that the second time interval is a time interval of less than about 10 ms, particularly of less than about 5 ms, more particularly of less than about 2 ms, after the golf player hits the golf ball. Preferably, two images of the golf ball directly after being hit by the golf club are acquired within 1.5 ms. This time interval allows to capture two images of the golf ball with a reasonable field of view of the respective camera. These images may allow to determine kinematic data of the flight of the golf ball as well as an identification of a position of the golf ball when being hit.

The first time interval may be a time interval of more than about 20 ms, particularly of more than about 200 ms, more particularly of more than about 300 ms, after the golf player hits a golf ball. Hence, the first acquisition unit recording the flight of the golf ball from a backward position can determine information indicative of the golf ball significantly later as compared to the second acquisition unit. In a preferred embodiment, the first acquisition unit determines one or more positions of the golf ball after 150 ms and after 400 ms after the hit.

The first image acquisition device and the second image acquisition device may be adapted so that acquiring the first information starts after finishing acquiring the second information. The system can be controlled in such a manner that at first the information of the motion of the ball perpendicular to the flight direction is measured, and subsequently the ball trajectory is analyzed from a backward position. This may allow to use the capabilities of the acquisition devices in an economic manner.

The data evaluation unit may be adapted for interpreting the first information based on a result of an evaluation of the second information. In such a highly advantageous embodiment, the interpretation of the first information can be significantly simplified and may be made more accurate when the second information has been evaluated beforehand. For instance, a camera as the second acquisition device detects a flying golf ball and captures, for instance, two pictures or snapshots thereof directly after the impact of a golf club on the golf ball. Particularly under difficult lightning conditions such as twilight, it may be difficult for the first acquisition device to recognize or identify the golf ball on an image captured from a rear position on which image the golf ball is far away from the golf diagnosis apparatus. When a rough approximation for such a position derived from the already evaluated second information is used for interpreting the first information, particularly for finding the golf ball on a possibly poorly resolved golf ball image of the first acquisition device, the system can predict a range where the golf ball is to be expected on the poorly resolved golf ball image of the first acquisition device. This does not only increase the accuracy of the golf diagnosis, but also reduces the processing time and computational burden for evaluating the first and the second information. In an embodiment in which both acquisition units are cameras, the measurement directly after the hit may allow to derive information such as initial position and velocity of the ball. This information confines the space in which the ball is to be expected at a later time, when capturing the first information. A similar principle can be applied to another preferred embodiment in which the ball trajectory directly after the hit is captured by a camera and the ball trajectory at a later time is captured by a radar or a lidar. Also in this case, the radar or lidar data may be interpreted in the light of the already analyzed camera data, thereby refining the results significantly.

The data evaluation unit may be adapted for determining a position of a golf ball on an image as the first information based on a motion characteristic of the golf ball derived from the second information. Hence, the static and kinematic properties of the ball after launching can be evaluated first and may then help an image recognition algorithm to determine a position of the golf ball on the image(s) taken from the rearward position.

The data evaluation unit may be adapted for determining a position of a golf ball on two images as the first information, may be adapted for determining a position of the golf ball on two images as the second information, and may further be adapted for determining the golf diagnosis related data based on the four determined positions. These four positions may be enough and may include sufficient information that the whole trajectory of the golf ball can be calculated with high precision.

The golf diagnosis apparatus may further comprise an optical trigger adapted for optically measuring a moment at which a golf ball is hit by the golf club. Such a system may use a laser pointer which directs a light beam towards a position close to the tee. When the player places a ball on the tee, this ball is enlightened with the laser light. When the ball is hit, no laser light is reflected from the ball, and this can be detected by the optical trigger to allow to measure a point of time at which the golf ball is hit by the golf club.

According to an embodiment, a laser pointer as an optical trigger may be used and may optionally be combined with a microphone as an acoustic trigger for triggering the second acquisition unit (preferably an optical camera) to capture one, two or more images of the golf ball directly after launching. Launching will cause an alteration of the illumination conditions of the laser pointer and will cause the generation of acoustic waves. The combination of an optical trigger with an acoustical trigger may allow for an extremely accurate control of time windows during which the first acquisition unit and/or the second acquisition unit capture data indicative of the motion of the golf ball.

In an embodiment, the optical trigger may be accommodated in and/or on the casing in a manner to allow a user to adjust an emission direction of a light beam emittable by the optical trigger by (for instance manually) tilting a housing of the optical trigger. In such an embodiment, the optical trigger mechanism may be arranged with a head protruding from a surface of the casing so that a user, with a single hand movement, can adjust the emission direction of the optical trigger towards a position where the user wishes to place the ball. In an alternative embodiment, the described optical trigger may be tilted automatically, for instance under control of a control unit. Hence, the system may adjust, in a machine-controlled manner, the emission direction of the optical trigger towards a position where the user has placed the ball.

In an embodiment, the velocity and rising angle of the golf ball can be calculated from the first two images of the golf ball (for instance captured with a time interval of 2 ms). This can be used for interpreting the second measurement. In other words, a result of the first measurement may be used as an estimate for interpreting the second measurement. This can be important for instance in embodiments in which also the second acquisition device is a camera and one of the two (or more) images of the ball cannot be clearly resolved from the background (for instance in a scenario of twilight). However, by estimating the trajectory of the ball based on the first measurement, the data space in the second measurement can be restricted within which the ball can be expected. This may allow to obtain meaningful results even in the case in which one or more of the images do not have a sufficient quality.

In the case of a radar measurement, the radar camera only has to know where the position of the ball has been at the point of time of the hit. This can be measured by an optical camera. Such a camera may measure the position of the ball which, in combination with the point of time of the hit of the ball allows to calculate the trajectory. For instance, a sphere calculated based on the optical data can be intersected with a data set of the radar to derive the trajectory with high precision.

The second acquisition device may be adapted for automatically identifying a golf club used by the golf player for hitting the golf ball.

In an embodiment, the second acquisition device may be adapted for identifying a golf club (such as identifying a type of golf club) on an image captured by the camera which golf club is used by the golf player for hitting the golf ball. This may be done by image processing. The apparatus may further comprise a memory device (or a storage device) adapted for storing the determined golf diagnosis related data in correlation with the identified golf club, in particularly further in correlation with an identify of the golf player. The identity of the golf player may be derived for instance by a registration procedure or from a member ID card inserted by the golfer in the apparatus. The golfer may then access the memory device or a dedicated part thereof, for instance via a communication network such as the public Internet.

The golf diagnosis apparatus may be adapted to be anti-theft protected.

Operation of the first acquisition device and operation of the second acquisition device may be coordinated so that evaluating the first information starts after evaluating the second information.

The golf diagnosis apparatus may comprise an optical trigger adapted for optically measuring a point of time at which the golf ball is hit by the golf player. The optical trigger may be accommodated in and/or on the casing in a manner to allow a user to adjust an emission direction of a light beam emittable by the optical trigger by tilting the optical trigger. The optical trigger may be configured for being automatically controlled to direct a light beam onto a golf ball.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

### BRIEF DESCRIPTION OF THE FIGURES

FIG. 1 to FIG. 3 show golf diagnosis systems according to exemplary embodiments of the invention.

FIG. 4 shows a three-dimensional view of a golf diagnosis apparatus according to an exemplary embodiment of the invention.

FIG. 5 shows a stroke analysis indicative of a result of a golf diagnosis performed by the apparatus of FIG. 4.

FIG. 6 shows an analysis of angles of a stroke performed by the golf diagnosis apparatus of FIG. 4.

FIG. 7 shows angle values for an optimum stroke.

FIG. 8 shows an optical trigger of a golf diagnosis apparatus according to an exemplary embodiment of the invention.

FIG. 9 shows an optimum spatial area in which the golf ball can be placed for optimum detection performance.

FIG. 10 illustrates a golf diagnosis apparatus according to an exemplary embodiment of the invention.

FIG. 11 illustrates a golf diagnosis apparatus according to an exemplary embodiment of the invention.

### DETAILED DESCRIPTION

The illustration in the drawing is schematically. In different drawings, similar or identical elements are provided with the same reference signs.

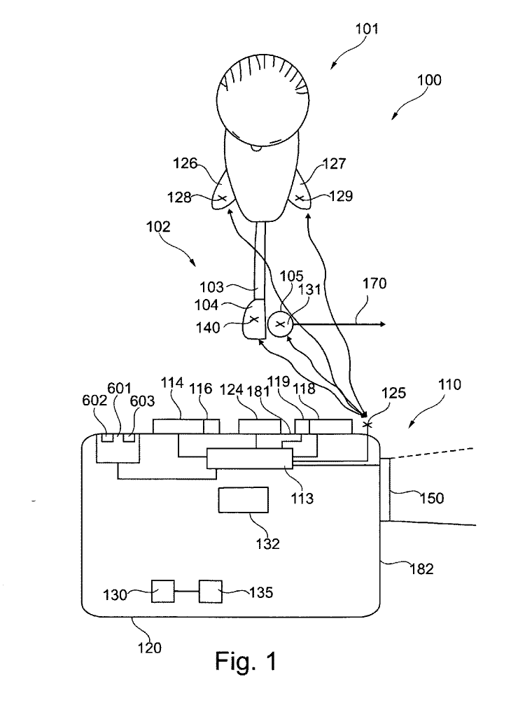

In the following, referring to FIG. 1, an autarkic golf diagnosis apparatus system 100 according to an exemplary embodiment of the invention will be described.

As shown in FIG. 1, a golf player 101 is in a position to carry a golf club 102 including a shaft 103 and a club head 104. A golf ball 105 is positioned on a tee (not shown).

Furthermore, FIG. 1 shows an autarkic golf diagnosis apparatus 110 which may be simply placed on or installed (for instance by screwing, concreting) on and/or in a ground. Components of the golf diagnosis apparatus 110 are embedded therein, so that the golf diagnosis apparatus 110 is integrally formed or formed as a single piece.

The golf diagnosis apparatus 110 comprises a central processing unit (CPU) 113 which includes processing resources and storage resources. The CPU 113 is the central control system over the entire golf diagnosis apparatus 110. The CPU 113 is electrically coupled (in a bidirectional manner or in a unidirectional manner) with a CCD (charge coupled device) camera 114. As an alternative to a CCD camera, a CMOS camera may be used. The CCD camera 114 is adapted to monitor the golf player 101 to derive information for evaluating a stroke of the golfer 101.

Furthermore, a flash 116 are provided. The flash 116 can be positioned at any desired position of the golf diagnosis apparatus 110 and may be integrally formed with a casing 120 of the golf diagnosis apparatus 110. The flash 116 may emit light flashes so as to define points of time at which images of the golf club 102, of the golf ball 105 and/or of the golf player 101 are captured by the camera 114. According to an exemplary embodiment, only golf ball 105 related data are evaluated. As an alternative for the flash 116, a strobe may be provided. It is possible to implement such a light flash source using LEDs, particularly OLEDs. The number of light pulses may vary, and can be larger or smaller than two.

Furthermore, the CPU 113 is coupled to an LCD, to a TFT, or to an OLED display 118 as an optical display unit for displaying results of the golf diagnosis apparatus 110. Moreover, the CPU 113 is coupled to an input/output device 119 like buttons, a keypad, a joystick, a touch screen, sensors, a touch screen or the like so as to provide the CPU 113 with control information. For instance, the golfer 101 may input, via the input/output device 119, information indicating a type of a club 102 which shall be used for the strike, so as to provide the system 110 with the required information needed to evaluate the stroke. The golfer 101 may also select an operation mode or a golf game via the input/output device 119.

Each of the components 114, 116, 118, 119 are fixedly connected or integrated within the casing 120 of the golf diagnosis apparatus 110.

As can be taken from FIG. 1, by providing all the components of the golf diagnosis apparatus 110 embedded in one housing 120, a small dimensioned apparatus may be provided which is appropriate for being installed on a driving range.

Furthermore, a battery 130 is located within the golf diagnosis apparatus 110 so as to supply the various components of the golf diagnosis apparatus 110 with electrical energy. Alternatively, the golf diagnosis apparatus 110 may be connected to a public mains supply.

As further shown in FIG. 1, a microphone 124 is provided for detecting acoustic waves resulting from a hit between the golf club head 104 and the ball 105. This hit signal may trigger the flash 116 to emit a sequence of flashes and the camera 114 to capture snap-shots of the golf ball 105 directly after the hit.

Furthermore, a Bluetooth communication interface 125 is foreseen at the golf diagnosis apparatus 110, and is coupled to the CPU 113. Via the Bluetooth communication interface 125, wireless communication with sensors 128, 129 located in both shoes 126, 127 of the golfer 101 is possible. Furthermore, wireless communication with a sensor 140 provided in the golf club head 104 and with a sensor 131 provided in the golf ball 105 is possible. However, the configuration with the communication between the communication interface 125 and the sensors 128, 129, 131, 140 is optional.

In the following, the functionality of the system 100 will be explained in more detail.

When the golf player 101 has operated the golf club 102 so that the club head 104 hits the ball 105, acoustic waves are generated. These are detected—with a corresponding delay—by the microphone 124. Consequently, the flash 116 is triggered to emit light pulses. Furthermore, points of time are defined by the flash 116 at which the camera 114 detects images of the hit ball 105, the moving club 102 and the moving golf player 101 (essentially) during or after the hit.

Optionally, sensor information from the sensors 128, 129, 131, 140 is transmitted to the Bluetooth communication interface 125. All these items of information may be used by the CPU 113 to derive golf diagnosis information, like angle information, velocity information, distance information, etc. A result of such an evaluation may be output via the display unit 118 is a visual or in an audiovisual manner.

As an alternative to the microphone 124, a light barrier may be provided for detecting the point of time of hitting the ball 105.

The golf diagnosis apparatus 110 is adapted for evaluating a stroke of the player 101 captured by the camera 114. The golf diagnosis apparatus 110 is embedded entirely in the housing 120. Particularly, the camera 114, the battery 130, the display 118, the input/output interface 119, the flashlight unit 116 and the data evaluation unit 113 are installed on and/or in the housing 120.

The camera 114 allows to capture images of the golfer 101 at various points of time. The pressure sensors 128, 129 allow to sense weight distributions of the golfer 101 body during the hit, which may be used for evaluating a quality of a stroke. Position sensors 140, 131 may allow to derive position information with regard to the club 102 and the ball 105 around the stroke.

Furthermore, FIG. 1 shows a solar cell 135 which may be used to recharge the battery 130. Alternatively, it is possible to recharge the battery using a connection to a mains supply (not shown).

The CPU 113 is coupled with a memory 132 in which various data may be stored which may be used for the evaluation of the stroke. Particularly, golf stroke evaluation algorithms, image processing algorithms, or the like may be stored in the memory 132.

The golf diagnosis apparatus 100 additionally comprises a payment unit 601 adapted for receiving coins or bills in a money reception slot 602 or a credit card in a credit card reception slot 603 as a means of payment from the user 101. The payment unit 601 then determines the amount of money paid by the user 101 for using the apparatus 110. The payment unit 601 will then send an enabling signal to the control unit 113 for enabling the user to operate the autarkic golf diagnosis apparatus 110 upon successful payment. Such a message may include information how long and/or for how many strokes and/or for how many holes the user 101 has paid and is therefore allowed to use the device 110 on a driving range at which the device 110 is installed.

The camera 114 in combination with the strobe 116 is capable of capturing multiple images of the golf ball 105 in the flight direction 170. In other words, the viewing direction of the camera 114 is essentially perpendicular to the flight direction 170.

In order to refine the reliability and accuracy of the golf diagnosis related data, a radar unit 150 is provided which is adapted for emitting primary radio waves essentially parallel to the flight direction 170 of the golf ball 105. When the golf ball 105 has left the tee, and flies in direction 170, the viewing direction of the radar unit 150 is arranged parallel to the golf ball flight so that the radar unit 150 can follow the golf ball flight over a long distance.

Therefore, the golf diagnosis apparatus 110 combines the image acquisition device 114, 116 for acquiring information indicative of the golf ball 105 flight with a camera viewing direction which is vertical according to FIG. 1, and also uses the radar acquisition device 150 for acquiring complementary information indicative of the golf ball flight along a radar viewing direction which is different, namely perpendicular, to the image viewing direction and is oriented horizontally according to FIG. 1, i.e. parallel to the flight direction 170.

The data evaluation unit 113 then evaluates the data captured by the image acquisition device 114, 116 and of the radar acquisition device 150, in a simultaneous, combinational, synergetic and complementary manner.

As can be taken from FIG. 1, a plan view or cross-section of the casing 120 is essentially rectangular (with rounded edges), wherein components of the image acquisition device 114, 116 are installed on a first sidewall 181 which is perpendicular to a second sidewall 182 at which the radar unit 150 is installed. By this mounting scheme, the mounting of the two acquisition devices 114, 116/150 promotes or defines the different viewing directions of the respective acquisition device 114, 116/150.

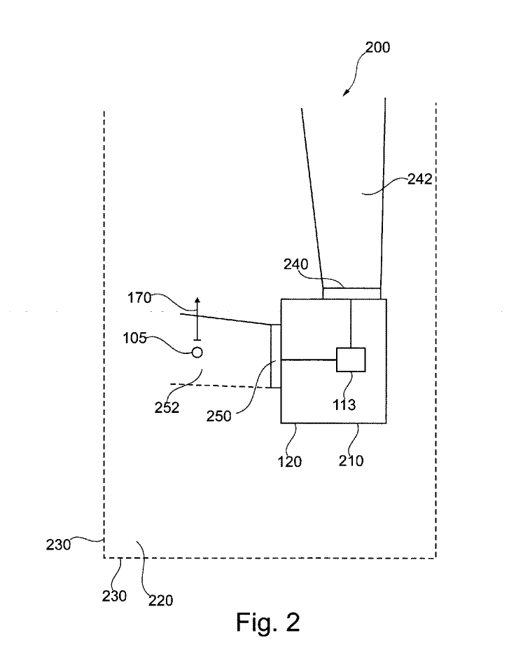

In the following, referring to FIG. 2, a golf diagnosis system 200 according to another exemplary embodiment of the invention will be explained.

The golf diagnosis system 200 comprises a golf diagnosis apparatus 210 which is installed within a bay 220 of a driving range delimited with regard to adjacent further bays via a boundary 230 (which may comprise separation elements such as wall elements).

A dimension of the golf diagnosis apparatus 210 (which may be denoted as a tower) in a horizontal direction of FIG. 2 is 0.2 m, a dimension of the tower 210 in a vertical direction according to FIG. 2 is 40 cm, and a height of the tower 210 perpendicular to the paper plane of FIG. 2 is 1.5 m in the present embodiment. All components of the golf diagnosis apparatus 210 are integrated within the casing 120.

A first acquisition device 240 is provided to have a viewing direction 242 (having no, essentially no or only a small angular extension) which is essentially parallel to the ball flight direction 170. A second acquisition device 250 has a viewing direction 252 (having no, essentially no or only a small angular extension) which is essentially perpendicular to the golf ball flight 170.

The first acquisition device 240 follows the ball from a backward direction during the flight. In contrast to this, the second acquisition device 250 only follows the ball 105 in the first moments after the launch. A control unit 113 evaluates both data signals from the devices 240, 250 simultaneously, in order to improve the accuracy of the golf diagnosis.

In the present embodiment, the first acquisition device 240 may be an acquisition device for capturing information being complementary to the information captured by the second acquisition device 250, and may be a snap shot camera, a high velocity camera capturing the ball flight or may be a radar measurement device. The second acquisition device 250 is a flashlight camera in the embodiment of FIG. 2.

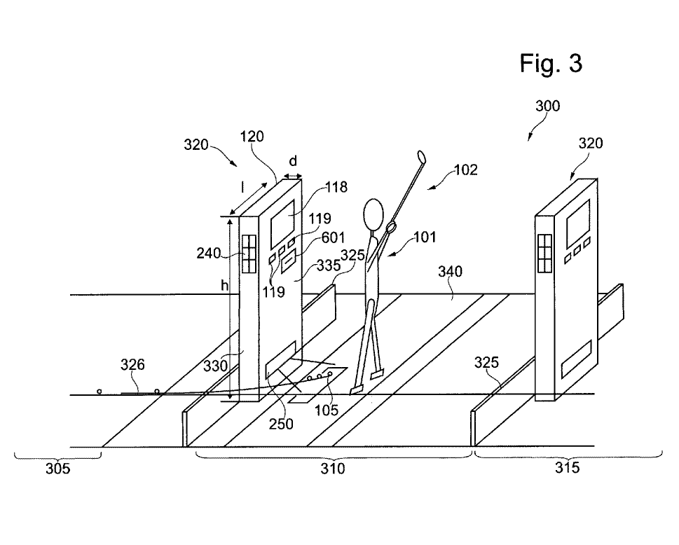

In the following, referring to FIG. 3, a golf diagnosis system 300 according to an exemplary embodiment of the invention will be explained.

The embodiment of FIG. 3 shows a three-dimensional schematic view of a number of different bays 305, 310, 315 of a driving range arranged parallel to one another. On each of these bays 305, 310, 315 which are arranged next to one another, a respective golf diagnosis apparatus 320 is provided. Separation walls 325 are provided between adjacent bays 305, 310, 315.

A golf player 101 carrying a golf club 102 hits the ball 105 which starts to fly along a trajectory 326.

The golf diagnosis apparatus 320 comprises a casing 120 which has a cuboid shape having a first dimension d, a second dimension l and a third dimension h. The dimension h is larger than the dimensions l, d, and the dimension l is larger than the dimension d. For example, the dimension h may be at least twice, particularly at least three times, larger than the dimension l, and the dimension l may be at least twice, particularly at least four times, larger than the dimension d. Thus, the casing 120 is a cuboid with an essentially plate-like shape which is designed with two dimensions being significantly larger than the third dimension. This geometry allows to install the golf diagnosis apparatus 120 with small required space.

A radar unit 240 is arranged on a front cover plate 330 of the casing 120. The radar unit 240 can be arranged at a vertically higher position than a strobe-based snap shot camera unit 250 arranged on one of the flat large area cover plates 335 of the casing 120 to face the golfer 101 when standing at the tee (alternatively, the radar unit 240 and the strobe-based snap shot camera unit 250 may both be positioned at the same height). The strobe-based camera 250 is arranged close to the ground 340, i.e. at a lower position than the radar unit 240. The base plates 330, 335 are arranged perpendicular to one another and adjacent to one another.

On the base plate 335 at which the strobe-based camera unit 250 is installed, a display device 118 is arranged as well as control buttons 119 and a payment unit 601. Thus, the user 101 striking the golf ball 105 does not have to change position for hitting the golf ball 105, paying by the payment unit 601, operating the golf diagnosis apparatus 320 via the buttons 119 and viewing golf diagnosis results on the screen 118. This is very convenient and simultaneously results in a compact design of the adjacent bays 305, 310, 315.

Thus, FIG. 3 shows launch monitors 320 which are precise and simultaneously compact so that a high precision level can be achieved and simultaneously low spatial requirements and a practical installation on a bay 305, 310, 315 are enabled. This can be achieved by the stroboscopic launch monitor 250 for a measurement of the ball flight in a lateral direction in combination with a measurement of the ball flight in a forward direction via the radar unit 240 (which alternatively can also be a video or triangulation unit), with all components being integrated within the same housing 120 together with the display 118 which is arranged opposing the golfer 101.

Thus, at each weather, the golf player 101 can enjoy a golf simulation/golf diagnosis to improve the golf skills in a rapid manner.

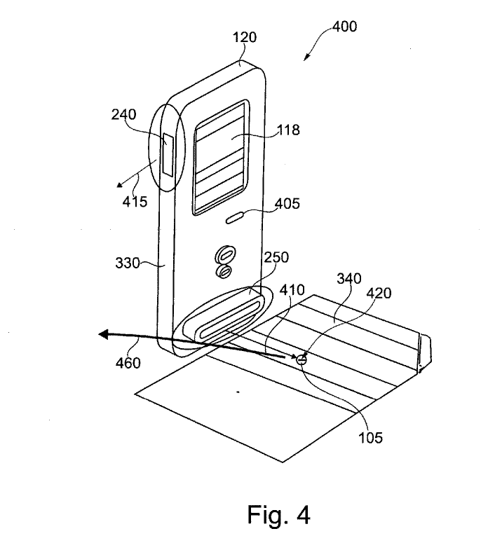

FIG. 4 shows a golf diagnosis apparatus 400 similar to the golf diagnosis apparatus 300 of FIG. 3.

In addition, a slot 405 is provided which may be used for inserting a credit card, a member card, a member ID card (including an identification of the user of the card), or the like for activating the golf diagnosis apparatus 400. A user wishing to use the golf diagnosis apparatus 400 may simply insert such a card in the slot 405. The golf diagnosis apparatus 400 will read the card for determining whether the card has sufficient credits to allow the user to use the golf diagnosis apparatus 400. If this is the case, the user may be informed regarding the remaining credits and may be requested to start the training. If this is not the case, the user may be informed that the card has to be loaded up with credits before starting the training.

The golf diagnosis apparatus 400 allows to perform a measurement of the ball motion in two directions, namely with a camera 250 for a measurement of a ball motion perpendicular to a camera alignment direction 410 and with a radar unit 240 for a measurement of a ball motion parallel to a radar direction 415. When the ball 105 is hit to fly along a trajectory 460 characterized by a corresponding motion vector defined by a geometry of the driving range, the camera alignment direction 410 will be basically perpendicular to the motion vector, whereas the motion vector has a component parallel to the radar direction 415. Due to the shown arrangement, the camera 250 will measure a close-up of the ball motion immediately after launching, whereas the radar 240 will measure a panoramic view from a rearward position.

In other preferred embodiments, the radar unit 440 may be substituted by a lidar unit or a further optical camera.

As can further be taken from FIG. 4, the golf ball 105 carries an inscription 420 as a marker for simplifying image processing. An image processing entity of the golf diagnosis apparatus 400 may recognize the orientation of the golf ball 105 during an early stage of the motion by determining the respective orientation of the marker, for instance for deriving spin information.

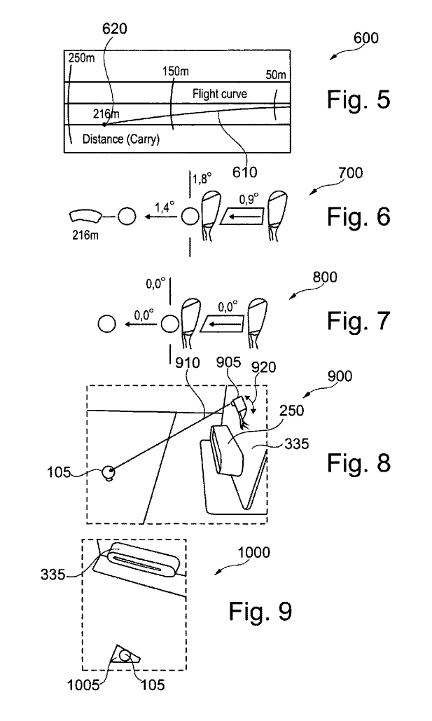

FIG. 5 shows an image 600 illustrating further details regarding the analysis of the stroke on the golf course and shows a flight curve 610 as well as a stroke distance 620, 215 m in the present case. In a very intuitive manner and without having to change the position after a stroke, a golf player may get an impression of the characteristics of the stroke allowing for a proper golf diagnosis. Thus, FIG. 5 shows how the ball has moved after the hit.

FIG. 6 is shows the angular characteristics of the stroke. This includes the display of a club angle at the moment of the hit as well as various ball angles. The self-explanatory display of FIG. 6 allows a user at a glance to correlate a quality of the stroke with angular positions of club and ball.

FIG. 7 shows a situation similar to FIG. 6 but illustrating an ideal stroke.

A portion of a golf diagnosis apparatus 900 shown in FIG. 8 shows, inter alia, a laser pointer 905 as an optical trigger for optically measuring a moment at which a golf ball 105 is hit by a club head. The optical trigger 905 is accommodated to protrude from the casing (see wall 335 thereof) in a manner to allow a user to manually adjust an emission direction of a light beam 910 emittable by the optical trigger 905. Such an adjustment may be performed by manually tilting the optical trigger 905. In other words, the optical trigger 905 has a tiltable head (see arrow 920) allowing to spatially adjust the laser pointer 910 regarding a ball position 105.

Proper measurement results may be achieved particularly when the ball 105 rests on a tee (see FIG. 8) before launch or is located within the triangle 1005 shown in an image 1000. This may be illustrated to a user in an intuitive manner by colouring such preferred launching positions with another colour than a surrounding portion.

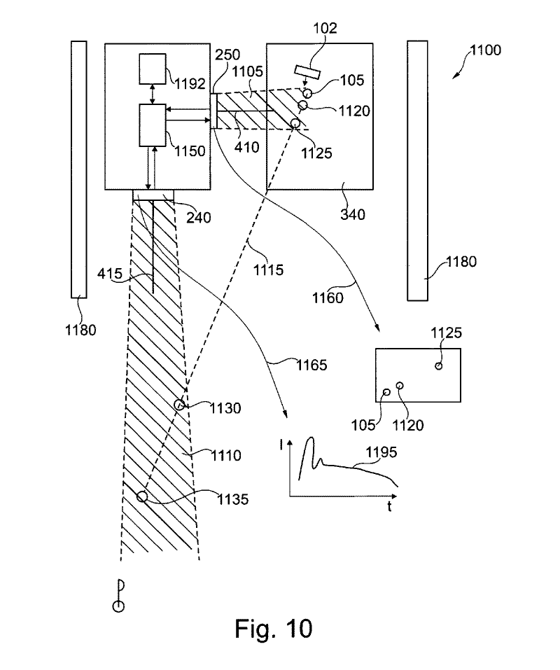

In the following, referring to FIG. 10, a golf diagnosis apparatus 1100 according to an exemplary embodiment of the invention will be explained.

The system of FIG. 10 is similar to the system shown in FIG. 3 and shows some further details and features which will be explained in the following.

A first field of view 1105 is illustrated in FIG. 10 for the camera 250. The first field of view 1105 shows an area or a volume in which the camera 250 is sensitive for capturing images. In other words, the camera 250 will capture information regarding the golf ball 105 directly after launch exclusively within the first field of view 1105. The camera alignment direction 410 forms a central axis of the first field of view 1105. The camera 250 may be operated in a snap shot mode or in a continuous video mode.

A second field of view 1110 is shown for the radar device 240. The second field of view 1110 shows an area or a volume in which the radar device 240 is sensitive for capturing data. In other words, the radar device 240 will capture information regarding the golf ball 105 in a later time window after launch exclusively within the second field of view 1110. The radar alignment direction 415 forms a central axis of the second field of view 1110. The radar device 240 may operate at a frequency of 24 GHz.

As can be taken from FIG. 10, the fields of view 1105, 1110 do not share any common volume and do not intersect, and are therefore arranged in a non-overlapping manner. This prevents the system 1100 from capturing data including the same information twice, thereby allowing for an efficient reduction of data to be evaluated and allowing for a very fast operation of the system. Hence, a user may be informed within a very short time after launching regarding the results of the golf diagnosis.

When a club 102 hits the ball 105 for launching, the ball 105 starts moving along a trajectory 1115. A system like the optical trigger 905 shown in FIG. 8 and FIG. 9 is capable of detecting a point of time at which the ball 105 is hit by the club 102. Upon detecting the launch, the camera 250 is triggered by a control unit 1150 (such as a microprocessor or a central processing unit, CPU) to capture images of the ball 105 at a first point of time (see reference numeral 1120) and at a second point of time (see reference numeral 1125). The images 1120, 1125 are captured within about 1.5 ms after the hit.

The ball moves along trajectory 1115, which is oriented (in the plan view or top view of FIG. 10) basically perpendicular to the camera alignment direction 410 and basically parallel to the radar alignment direction 415. During the flight, the ball 105 first leaves the field of view 1105 of the camera device 250 and then, after an intermediate time interval, enters the field of view 1110 of the radar device 240. The radar device 240 then captures two images of the ball 105 at a third point of time (see reference numeral 1130) and at a fourth point of time (see reference numeral 1135).

The time interval during which the camera 250 captures the images of the ball 105 is few milliseconds, whereas the time interval during which the radar device 240 captures the images 1130, 1135 is significantly larger, for instance several hundred milliseconds. The acquisition of meaningful data by the radar device 240 starts later than the acquisition of the images 1120, 1125 by the camera 250.

FIG. 10 shows that the control unit 1150 may also serve as a data evaluation unit. The control unit 1150 is coupled for a bidirectional communication with the camera 250 and the radar 240. The process flow may be as follows: After having captured the images 1120, 1125, the data evaluation unit 1150 calculates information regarding velocity, spin, angles, etc. of the shot on the basis of the images acquired by the camera 250. Reference numeral 1160 schematically shows images of the golf ball 105 during the movement as captured by the camera 250.

Only after having determined these motion parameters regarding the trajectory 1115 or characterizing the trajectory 1115, the data evaluation unit 1150 starts evaluating measurement data captured by the radar device 240. Such measurement data 1165 is shown in FIG. 10 as well. However, particularly under undesired conditions, it can be difficult to evaluate the radar spectrum 1165 (or in another embodiment in which the radar device 240 is substituted by a second camera to clearly identify spots 1130, 1135 on an image) without any additional information with high accuracy. Problems may result from artifacts of the spectrum (see reference numeral 1195) or from a poorly resolved spectrum obtained under undesired external conditions such as heavy rainfall. For making such an evaluation faster and easier and for thereby increasing the accuracy and reliability of the evaluation, the data or parameters derived from the optical measurement (see reference numeral 1160) can be used as a basis for interpreting the curve 1165. In other words, the data evaluation unit 1150 is adapted for interpreting the radar data in the light of a result of the previous evaluation of the optical data. This reduces the data space to be analyzed by the control unit 1150 for the evaluation of the two data sets provided by the complementary measurement units 240, 250.

Results of the data evaluation may be displayed to the user by an input/output unit 1192 which may include input elements such as buttons and which may include output elements such as a visual display, a loudspeaker, etc.

FIG. 10 further shows separation walls 1180 for spatially separating the golf diagnosis apparatus 1100 from neighbored sections of a driving range. The separation walls 1180 extend perpendicular to the camera alignment direction 410 and extend parallel to the radar alignment direction 415.

Under undesired circumstances, a body motion of the golf player during launching the ball may have the effect that mechanical vibrations or shocks influence or affect the golf diagnosis apparatus 1100. This may result in a deterioration of the accuracy of the golf diagnosis, since a spatial shift of different images of the ball (see for instance reference numeral 1160) due to slight mechanical movement of the apparatus 1100 may result in artifacts when calculating motion data from such difference images. In order to compensate for such artifacts, exemplary embodiments of the invention may remove such artifacts by using an autocorrelation method allowing to eliminate positional shifts due to oscillations. Moreover, constructional measures may be taken when designing and anchoring the golf diagnosis apparatus 1100 to keep a motion of the golf diagnosis apparatus 1100 as small as possible.

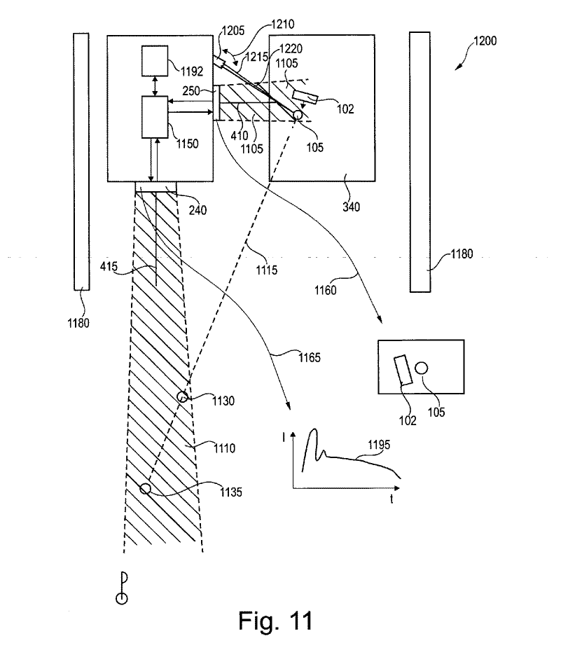

In the following, referring to FIG. 11, a golf diagnosis apparatus 1200 according to an exemplary embodiment of the invention will be explained.

In the embodiment of FIG. 11, a radar device 240 is combined with a ball finder system formed by the camera 250 and an automatically operating optical trigger unit 1205.

FIG. 11 shows a scenario in which the ball 105 rests on the ground 340. In this situation, the camera 250 captures an image of the area defined by the field of view 1105. The corresponding image data is transmitted to the control or data evaluation unit 1150 which may detect the position of the resting ball 105, for instance by image processing and pattern recognition. In accordance with the determined ball position, the control unit 1150 controls the optical trigger unit 1205 to pivot automatically (compare reference numeral 1210) so that a light beam 1215 emitted by a laser source of the optical trigger unit 1205 is directed onto the golf ball 105. A light beam 1220 generated upon reflection of the light beam 1215 at a surface of the golf ball 105 is detected by a photocell of the optical trigger unit 1205. In case that the photocell detects that the reflected intensity is smaller than necessary for a meaningful detection of the point of time at which the ball 105 is launched (for instance is smaller than a predefined threshold value), the control unit 1150 may control the optical trigger unit 1205 to move within a limited area on the surface of the ball which area is smaller than the field of view 1105. Such a too small intensity may result when the beam 1220 is directed onto a dark inscription on the golf ball 105. Spatially scanning a potential area in which the ball 105 could be placed may be performed in the context of a feedback loop. During its motion, the optical trigger unit 1205 searches for a position at which a sufficient intensity of the reflected light beam 1220 can be measured. In order to prevent a golfer to be dazzled by light, the optical trigger unit 1205 starts to scan the surface of the golf ball 105 first in a downward direction, if necessary followed by a scan in a sideward direction.

This automatic ball finding procedure may allow a user to make use of the apparatus 1200 in a very convenient way, since the golfer only needs to place the golf ball 105 at any desired position within the field of view 1105 of the camera 250, and the automatic ball finding procedure will automatically determine this position.

When the club 102 hits the golf ball 105 for launching, this point of time can be detected by the optical trigger unit 1205 as a point of time at which the photocell can no longer detect the reflected light beam 1220. In an embodiment in which a very high reliability of a correct detection of the point of time of launching is required, a microphone unit (not shown) may be provided in addition to the optical trigger unit 1205 as an acoustic trigger detector. Such a microphone unit may recognize launching by detecting corresponding acoustic waves resulting from the golf club 102 hitting the golf ball 105. Under undesired circumstances, it may happen that the club 102 is moved by a golfer into a spatial area between the optical trigger unit 1205 and the ball 105 even in the absence of a launch. In this situation, the optical trigger unit 1205 would (incorrectly) detect a launching, but the microphone would (correctly) detect no launching. Hence, launching may be assumed to occur in case that (within suitably chosen time windows) both the optical trigger unit 1205 and the acoustical trigger unit detect a launching.

The described ball finder system is therefore capable of detecting both the position of the golf ball 105 in a resting state as well as the point of time at which the golf ball 105 is hit by the golf club 102. This information may be sufficient for deriving the golf diagnosis data from the 3D information captured by the radar device 240 in the manner as described above. In other words, the radar data is interpreted in the light of the ball position and launch time information obtained by the ball finder system.

As can be taken from the schematic image captured by the camera 250, the latter may not only detect the ball 105 in the resting position, but also the club 102 can be detected. By applying appropriate image processing algorithms, for instance using pattern recognition, the control unit 1150 may determine the kind or class or type of golf club 102 used by the golf player (for instance whether the golf club 102 is an iron (and which iron, for instance iron 5 or iron 9), a wood (and which wood, for instance wood 3 or wood 5), a putter, a wedge, etc.). It is also possible that further information regarding the golf club 102 such as manufacturer information may be determined by the control unit 1150. For this purpose, it is possible to detect shape, colour, etc. of the golf club 102. Also one or more markers or an inscription on the golf club 102 may be evaluated. Such a processing may allow to assign a used club 102 to a stroke and the corresponding golf diagnosis data of a specific golf player. Thus, grouped information may be stored such as: “Golfer XY: stroke widths with wood 1: 120 m, 123 m, 134 m; wood 5: 88 m, 89 m, 98 m, 102 m; iron 5: 78 m, 78 m, . . . ”.

In an embodiment, a golfer inserts a member ID card into the apparatus 1200 which may include a number of credits (or strokes for which the golfer has paid) as well as the identity of the user. The apparatus 1200 may read this information and may add the derived golf diagnosis data of each stroke of a golfer to a database (for instance stored on a hard disk of the apparatus 1200 or on a server communicatively coupled to the Internet). The grouped information may be accessed by the golfer based on a identification code.

Summarizing, particularly the following embodiments are preferred:—the combination of a camera capturing several images of a golf ball directly after launching with a further camera capturing several images of the golf ball later after launching, wherein the further camera data are evaluated with the knowledge of the evaluated camera data; the combination of a camera-based ball finder detecting position and launch time of a golf ball with a radar unit capturing several images of the golf ball later after launching, wherein the radar data are evaluated with the knowledge of the evaluated camera-based ball finder data.

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A golf diagnosis apparatus, comprising
a first acquisition device adapted for acquiring first information indicative of a performance, particularly a stroke, of a golf player, the first acquisition device being directed along a first direction;
a second acquisition device adapted for acquiring second information indicative of the performance, particularly the stroke, of the golf player, the second acquisition device being directed along a second direction which differs from the first direction; and
a data evaluation unit adapted for evaluating the first information and the second information to determine golf diagnosis related data;
wherein the first direction is parallel to and the second direction is perpendicular to a motion vector of a golf ball hit by the golf player.

2.-3. (canceled)

4. The golf diagnosis apparatus of claim 1,
wherein the first acquisition device comprises one of the group consisting of a camera for capturing one or more snap shots of a golf ball hit by the golf player, a camera for capturing a video of a golf ball hit by the golf player, an ultrasound detector for capturing ultrasound of a golf ball hit by the golf player, a radar unit for emitting primary electromagnetic radiation to a golf ball hit by the golf player and for receiving secondary electromagnetic radiation from the golf ball in response to the reflection of the primary electromagnetic radiation at the golf ball, and a lidar unit for emitting primary electromagnetic radiation to a golf ball hit by the golf player and for receiving secondary electromagnetic radiation from the golf ball in response to the reflection of the primary electromagnetic radiation at the golf ball.

5. The golf diagnosis apparatus of claim 1,
wherein the second acquisition device comprises one of the group consisting of a camera for capturing one or more snap shots of a golf ball hit by the golf player, a camera for capturing a video of a golf ball hit by the golf player, an ultrasound detector for capturing ultrasound of a golf ball hit by the golf player, a radar unit for emitting primary electromagnetic radiation to a golf ball hit by the golf player and for receiving secondary electromagnetic radiation from the golf ball in response to the reflection of the primary electromagnetic radiation at the golf ball, and a lidar unit for emitting primary electromagnetic radiation to a golf ball hit by the golf player and for receiving secondary electromagnetic radiation from the golf ball in response to the reflection of the primary electromagnetic radiation at the golf ball.

6. The golf diagnosis apparatus of claim 1,
wherein the first acquisition device comprises a radar unit for emitting primary electromagnetic radiation to a golf ball hit by the golf player and for receiving secondary electromagnetic radiation from the golf ball in response to the reflection of the primary electromagnetic radiation at the golf ball; and
wherein the second acquisition device comprises a camera for capturing one or more snap shots of a golf ball hit by the golf player.

7. The golf diagnosis apparatus of claim 1,
wherein the first acquisition device comprises a radar unit for emitting primary electromagnetic radiation to a golf ball hit by the golf player and for receiving secondary electromagnetic radiation from the golf ball in response to the reflection of the primary electromagnetic radiation at the golf ball; and
wherein the second acquisition device comprises a ball finder system for detecting a launch position and a launch time of a golf ball hit by the golf player.

8. The golf diagnosis apparatus of claim 1,
wherein the first acquisition device comprises a camera for capturing one or more snap shots of a golf ball hit by the golf player; and
wherein the second acquisition device comprises a camera for capturing one or more snap shots of the golf ball hit by the golf player.

9.-12. (canceled)

13. The golf diagnosis apparatus of claim 1,
comprising a casing in and/or on which the first acquisition device, the second acquisition device and the data evaluation unit are accommodated.

14. The golf diagnosis apparatus of claim 13,
wherein the casing has a cuboid shape having six cover surfaces, wherein the first acquisition device is arranged at a first cover surface and the second acquisition device is arranged at a second cover surface, wherein the first cover surface and the second cover surface are adjacent to one another and are perpendicular to one another.

15.-29. (canceled)

30. The golf diagnosis apparatus of claim 1,
wherein a field of view of the first acquisition device is arranged in a non-overlapping manner with a field of view of the second acquisition device.

31. The golf diagnosis apparatus of claim 1,
wherein the first acquisition device is adapted for acquiring the first information within a first time interval;
wherein the second acquisition device is adapted for acquiring the second information within a second time interval preceding the first time interval.

32. The golf diagnosis apparatus of claim 31,
wherein the second time interval is a time interval of less than 10 ms, particularly of less than 5 ms, more particularly of less than 2 ms, after the golf player hits a golf ball.

33. The golf diagnosis apparatus of claim 31,
wherein the first time interval is a time interval of more than 20 ms, particularly of more than 200 ms, more particularly of more than 300 ms, after the golf player hits a golf ball.

34. The golf diagnosis apparatus of claim 1,
wherein operation of the first acquisition device and operation of the second acquisition device are coordinated so that acquiring the first information starts after finishing acquiring the second information.

35. (canceled)

36. The golf diagnosis apparatus of claim 1,
wherein the data evaluation unit is adapted for interpreting the first information based on a result of an evaluation of the second information.

37. The golf diagnosis apparatus of claim 1,
wherein the data evaluation unit is adapted for determining a position of a golf ball on an image as the first information based on a motion characteristic of the golf ball derived from the second information.

38. The golf diagnosis apparatus of claim 1,
wherein the data evaluation unit is adapted for determining a position of a golf ball on two images as the first information, for determining a position of the golf ball on two images as the second information, and for determining the golf diagnosis related data based on the four determined positions.

39. The golf diagnosis apparatus of claim 1,
comprising an optical trigger adapted for optically measuring a point of time at which the golf ball is hit by the golf player.

40. The golf diagnosis apparatus of claim 39,
wherein the optical trigger is accommodated in and/or on the casing in a manner to allow a user to adjust an emission direction of a light beam emittable by the optical trigger by tilting the optical trigger.

41. (canceled)

42. A method of performing golf diagnosis, the method comprising:
acquiring first information indicative of a performance, particularly a stroke, of a golf player by a first acquisition device being directed along a first direction;
acquiring second information indicative of the performance, particularly the stroke, of the golf player by a second acquisition device being directed along a second direction which differs from the first direction; and
evaluating the first information and the second information to determine golf diagnosis related data;
wherein the first direction is parallel to and the second direction is perpendicular to a motion vector of a golf ball hit by the golf player.

43. A method of using a golf diagnosis apparatus of claim 1 on a driving range.
